(19) United States
(12) Patent Application Publication
(10) Pub. No.: US 2026/0172676 A1
(43) Pub. Date: Jun. 18, 2026

(54) IMAGE PICKUP APPARATUS, DISPLAY CONTROL APPARATUS, CONTROL METHOD FOR IMAGE PICKUP APPARATUS, AND STORAGE MEDIUM THAT ENABLE DISPLAY REGARDING DEFOCUS AMOUNTS SUITABLE FOR A PLURALITY OF PHOTOGRAPHING MODES

(71) Applicant: CANON KABUSHIKI KAISHA, Tokyo (JP)

(72) Inventor: SHINJI HISAMOTO, Kanagawa (JP)

(21) Appl. No.: 19/393,788

(22) Filed: Nov. 19, 2025

(30) Foreign Application Priority Data
Dec. 18, 2024 (JP) 2024-221505

(51) Int. Cl. H04N 23/667; H04N 23/60; H04N 23/63; H04N 23/67

(52) U.S. Cl. CPC H04N 23/667; H04N 23/632; H04N 23/64; H04N 23/67

(57) ABSTRACT

An image pickup apparatus enabling display regarding defocus amounts suitable for multiple photographing modes is provided. The image pickup apparatus includes an image pickup unit capable of photographing a still image and a moving image as a photographed image, a member for switching a photographing mode among a still image photographing mode, a moving image photographing mode, and a standby mode, a generating unit that obtains defocus amounts in the photographed image and generates a defocus map image, and a display control unit that displays a superimposed image in which the photographed image and the defocus map image are superimposed. The generating unit, when the photographing mode is the moving image photographing mode or the standby mode, generates a first map image using multiple colors, and when the photographing mode is the still image photographing mode, generates a second map image in which the number of colors used is reduced.

### BACKGROUND

### Field of the Technology

The present disclosure relates to an image pickup apparatus, a display control apparatus, a control method for the image pickup apparatus, and a storage medium.

### Description of the Related Art

With an image pickup apparatus, subject detection is performed. In this subject detection, an image processing for visually displaying whether a subject is in focus or not is performed. With this image processing, for example, when photographing a moving image, a user is able to confirm (check) the depths of parts (for example, the background, etc.) other than a main subject, which are included in the moving image, by understanding (grasping) defocus amounts of the entire moving image. For example, Japanese Patent No. 7380675 discloses a configuration in which, a defocus map image indicating a distribution of defocus amounts in a captured image is generated by attaching a color in accordance with the defocus amount at each position in the captured image, and the defocus map image is displayed superimposed on the captured image. Japanese Patent No. 7435592 discloses a configuration in which, depending on an external output device to be used for performing an output, a first image output for causing to display a captured image without causing to display a defocus map image is performed, or a second image output for causing to display a captured image including the display of a defocus map image is performed. In addition, Japanese Patent No. 7435592 discloses a configuration in which, by performing a plurality of image outputs with different contents, a display control of the first image output or the second image output is capable of being performed for each output device.

However, with the configuration disclosed in Japanese Patent No. 7380675, in the case of photographing a moving image, it is possible to confirm (check) the depths of parts other than a main subject, which are included in the moving image, but in the case of photographing a still image, it becomes difficult to instantly confirm (check) whether or not the main subject is in focus. This is because in a color contour display in which a color in accordance with the defocus amount at each position in the captured image is attached, the user is distracted by the flickering of colors around the main subject, which makes it difficult to confirm (check) whether or not the main subject is in focus. In addition, in the configuration disclosed in Japanese Patent No. 7435592, the display control of the first image output or the second image output is performed, but this display control is not a display control suitable for focusing on the main subject in still image photographing.

### SUMMARY

The present disclosure provides an image pickup apparatus, a display control apparatus, a control method for the image pickup apparatus, and a storage medium that enable display regarding defocus amounts suitable for a plurality of photographing modes.

Accordingly, a first aspect of the present disclosure provides an image pickup apparatus comprising an image pickup unit configured to be capable of photographing a still image and a moving image as a photographed image, a mode switching member for switching a photographing mode among a still image photographing mode in which the still image is capable of being photographed by the image pickup unit, a moving image photographing mode in which the moving image is capable of being photographed by the image pickup unit, and a standby mode in which the image pickup apparatus is capable of standing by until switching to the still image photographing mode or the moving image photographing mode, at least one processor, and a memory coupled to the processor storing instructions that, when executed by the processor, cause the processor to function as a generating unit that obtains defocus amounts in the photographed image and generates a defocus map image that indicates a distribution state of the defocus amounts in the photographed image, and a display control unit that performs a control that displays a superimposed image in which the photographed image and the defocus map image have been superimposed. The generating unit, in a case where the photographing mode is the moving image photographing mode or the standby mode, as the defocus map image, generates a first map image which uses a plurality of colors, and in a case where the photographing mode is the still image photographing mode, as the defocus map image, generates a second map image in which the number of colors used is reduced compared to the first map image.

Accordingly, a second aspect of the present disclosure provides a display control apparatus comprising an obtaining unit configured to be capable of obtaining a still image and a moving image as a photographed image, the obtaining unit obtaining the still image in a case of a still image photographing mode and obtaining the moving image in a case of a moving image photographing mode, at least one processor, and a memory coupled to the processor storing instructions that, when executed by the processor, cause the processor to function as a generating unit that obtains defocus amounts in the photographed image and generates a defocus map image that indicates a distribution state of the defocus amounts in the photographed image, and a display control unit that performs a control that displays a superimposed image in which the photographed image and the defocus map image have been superimposed. The generating unit, in a case of the moving image photographing mode or a standby mode in which the image pickup apparatus is capable of standing by until switching to the still image photographing mode or the moving image photographing mode, as the defocus map image, generates a first map image which uses a plurality of colors, and in a case of the still image photographing mode, as the defocus map image, generates a second map image in which the number of colors used is reduced compared to the first map image.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram that illustrates an example of a hardware configuration of a camera that is an image pickup apparatus according to a first embodiment.

FIG. 2A and FIG. 2B are plan views that illustrate a configuration of an image pickup device included in an image pickup unit.

FIG. 3 is a block diagram that illustrates an example of a software configuration (functions) of an image processing unit.

FIG. 4A, FIG. 4B, and FIG. 4C are flowcharts that show processing executed by the camera.

FIG. 5 is a diagram that illustrates an example of a captured image.

FIG. 6 is a diagram that illustrates an example of a defocus map image to be superimposed on the captured image shown in FIG. 5.

FIG. 7A and FIG. 7B are diagrams that illustrate an example of a captured image after distortion and blur correction and an example of a defocus map image after the distortion and blur correction.

FIG. 8A and FIG. 8B are diagrams for explaining conversion from a defocus amount into α information.

FIG. 9 is a diagram that illustrates an example of a map superimposed image.

FIG. 10A and FIG. 10B are diagrams that illustrate examples of a visual recognition state of the map superimposed image.

FIG. 11 is a flowchart that shows processing executed by a camera according to a second embodiment.

FIG. 12A and FIG. 12B are diagrams for explaining modified examples of the second embodiment.

FIG. 13 is a flowchart that shows processing executed by a camera according to a third embodiment.

FIG. 14 is a diagram that illustrates an example of a usage state of the camera according to the third embodiment.

### DESCRIPTION OF THE EMBODIMENTS

The present disclosure will now be described in detail below with reference to the accompanying drawings showing embodiments thereof.

Hereinafter, each embodiment of the present disclosure will be described in detail with reference to the drawings. However, the configuration described in each embodiment below is merely an example, and the scope of the present disclosure is not limited by the configuration described in each embodiment. For example, each unit (each component) constituting the present disclosure can be replaced with a unit (a component) with any configuration that can perform the same function(s). In addition, any component(s) may be added. Furthermore, any two or more configurations (features) of each embodiment can be combined.

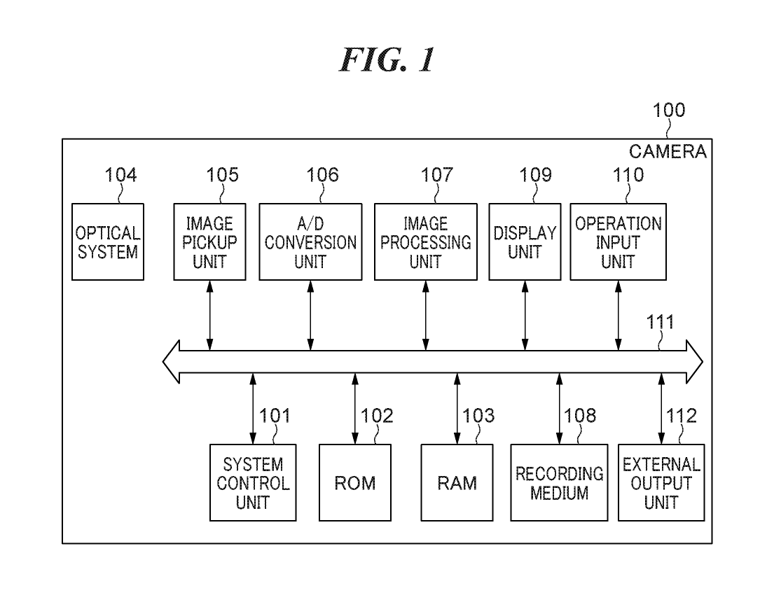

A first embodiment of the present disclosure will be described below with reference to FIGS. 1 to 10B. FIG. 1 is a block diagram that illustrates an example of a hardware configuration of a camera that is an image pickup apparatus according to the first embodiment. As shown in FIG. 1, a digital camera (hereinafter, simply referred to as “a camera”) 100 includes a system control unit 101, a read only memory (a ROM) 102, and a random access memory (a RAM) 103. In addition, the camera 100 includes an optical system 104, an image pickup unit (an image pickup means) 105, an A/D conversion unit 106, an image processing unit 107, a recording medium 108, a display unit (a display means) 109, an operation input unit 110, and an external output unit 112. These pieces of hardware included in the camera 100 are communicably connected to each other via a bus 111. It should be noted that in the first embodiment, a digital camera is used as the camera 100, but the present disclosure is not limited to this, and for example, a digital video camera, a smartphone, a wearable camera, or the like is also capable of being used as the camera 100.

The system control unit 101 is a computer that performs the control of each piece of hardware included in the camera 100. The system control unit 101 includes, for example, a central processing unit (a CPU), etc., and reads out an operating program from the ROM 102, loads the operating program into the RAM 103, and executes the operating program. It should be noted that the operating program is capable of causing the system control unit 101 to execute, for example, respective steps (respective processes), that is, a control method for the image pickup apparatus, which will be described below. The ROM 102 is a rewritable nonvolatile memory such as a flash ROM. In addition to the operating program, the ROM 102 stores parameters and the like that are required for the operation of each piece of hardware included in the camera 100. The RAM 103 is a rewritable volatile memory. The RAM 103 is used as a loading area, into which the operating program is loaded. In addition, the RAM 103 is also used as a storage area for temporarily storing intermediate data output by the operation of each piece of hardware included in the camera 100. In the first embodiment, the RAM 103 is also used as a working memory for the system control unit 101 and the image processing unit 107.

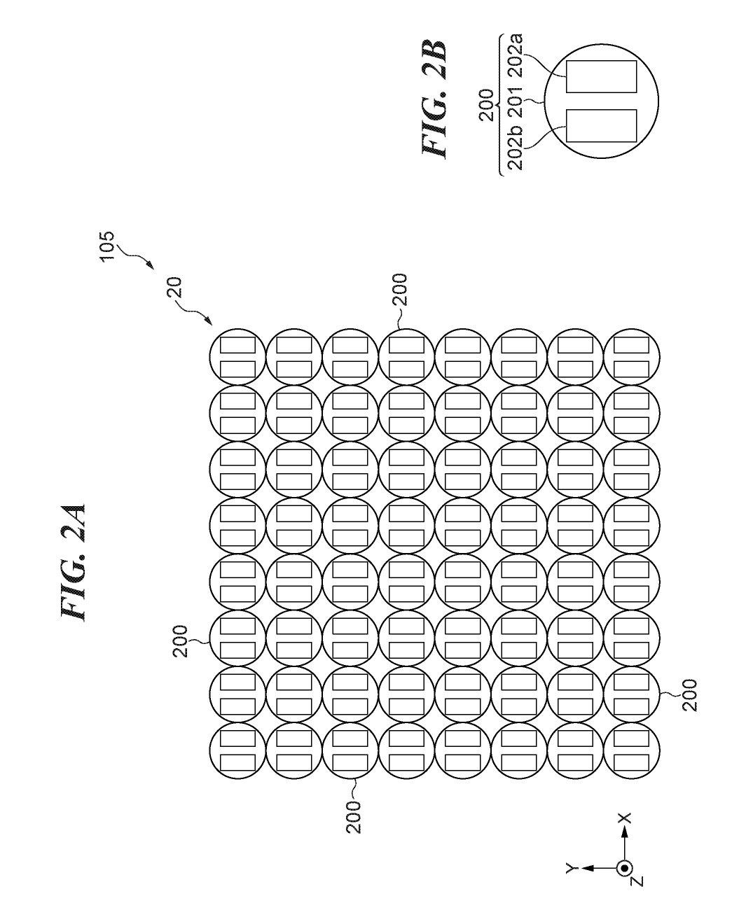

The optical system 104 is an image pickup optical system that forms an image of light from a subject on the image pickup unit 105. The optical system 104 includes, for example, a fixed lens, a variable magnification lens (a zooming lens) that changes a focal length, a focusing lens that performs focus adjustment, etc. In addition, the optical system 104 includes a diaphragm. The aperture diameter of the optical system 104 is adjusted by this diaphragm, and light amount adjustment during photographing is performed. The image pickup unit 105 includes an image pickup device 20 (see FIG. 2A and FIG. 2B) such as a charge-coupled device (CCD) image sensor or a complementary metal-oxide semiconductor (CMOS) image sensor, and is capable of photographing (capturing) still image(s) and moving image(s) as photographed image(s) (captured image(s)). Specifically, the image pickup unit 105 performs photoelectric conversion with respect to the optical image formed on an image pickup surface of the image pickup device 20 by the optical system 104, and outputs analog image signals to the A/D conversion unit 106. The A/D conversion unit 106 receives the analog image signals, which are output from the image pickup unit 105, and performs an A/D conversion processing with respect to the analog image signals. As a result, digital image data (hereinafter, sometimes simply referred to as “image data”) is obtained. The image data is stored in the RAM 103. In this way, in the first embodiment, the RAM 103 functions as an obtaining means (an obtaining unit) capable of obtaining photographed image(s) that has(have) been captured by the image pickup unit 105 (captured image(s)), that is, capable of obtaining still image(s) and moving image(s). It should be noted that the camera 100 is communicably connected to an external apparatus in which captured image(s) has(have) been saved (stored). In this case, the RAM 103 is also capable of storing the captured image(s) that has(have) been transferred from the external apparatus.

The image processing unit 107 performs various kinds of image processing with respect to the image data that has been stored in the RAM 103. Specifically, in the case where Bayer RGB image data has been input, the image processing unit 107 performs a synchronization processing with respect to the Bayer RGB image data to generate color signals R, color signals G, and color signals B. Then, the image processing unit 107 performs a gain multiplication processing with respect to the color signals R, the color signals G, and the color signals B, based on a gain value for white balance adjustment, thereby adjusting the white balance. In addition, the image processing unit 107 performs a processing that generates luminance signals Y from the RGB signals (the color signals R, the color signals G, and the color signals B), and performs various kinds of processing such as a contour enhancement processing and a luminance gamma correction with respect to the luminance signals Y. In addition, the image processing unit 107 performs a matrix calculation or the like with respect to the color signals R, the color signals G, and the color signals B, performs a conversion into a desired color balance and the gamma correction, and then generates color difference signals UV. The image data that has been subjected to the image processing which have been described above is recorded on the recording medium 108. The recording medium 108 is not particularly limited, and may be, for example, a memory card or the like that is attachable to and detachable from the camera 100. The image data (captured image data) that has been subjected to the image processing by the image processing unit 107, image signals (a RAW image) that have been A/D converted by the A/D conversion unit 106, and the like are recorded on the recording medium 108.

The display unit 109 includes a display device such as a liquid crystal display device (an LCD), and displays, for example, the photographed image that has been captured by the image pickup unit 105 (the captured image), various kinds of information related to the camera 100, etc. The display unit 109 is capable of performing a through display of the A/D-converted image data, for example, while the image pickup unit 105 is capturing an image. In this way, the display unit 109 functions as a digital viewfinder. In addition, the display unit 109 is also capable of displaying a map superimposed image in which a defocus map image that will be described below and a photographed image (a captured image) are superimposed. The control of causing the display unit 109 to display the map superimposed image (a display control step) is performed by the system control unit 101 (a display control unit serving as a display control means). In this way, in the first embodiment, the camera 100 functions as a display control apparatus that controls image display.

The operation input unit 110 is used as a user input interface and includes, for example, a release switch, and setting buttons for setting photographing conditions. In addition, the operation input unit 110 includes a mode setting dial. The mode setting dial is a mode switching means (a mode switching member) for performing an operation of switching between photographing modes. The photographing modes in the first embodiment include a still image photographing mode, a moving image photographing mode, and a standby mode. The still image photographing mode is a mode in which still image(s) is(are) capable of being photographed (captured) by the image pickup unit 105. The moving image photographing mode is a mode in which moving image(s) is(are) capable of being photographed (captured) by the image pickup unit 105. The standby mode is a mode in which the camera 100 is capable of standing by until switching to the still image photographing mode or the moving image photographing mode. In addition, the operation input unit 110 also functions as an instructing means (an instructing member) for performing operations to instruct a start and an end of photographing in the still image photographing mode and a start and an end of photographing in the moving image photographing mode. In the case where the operation input unit 110 has detected an operation input performed by the user, the operation input unit 110 outputs, to the system control unit 101, a signal corresponding to the operation input performed by the user. It should be noted that in the case where the display unit 109 includes a touch panel, the operation input unit 110 also functions as an interface that detects a touch operation on the touch panel. The external output unit 112 is a terminal for externally outputting video data (the image data), and for example, is a serial digital interface (SDI) terminal or a high-definition multimedia interface (HDMI (registered trademark)) terminal. The external output unit 112 is capable of being connected to a display that is an external device and/or an external recording device.

FIG. 2A and FIG. 2B are plan views that illustrate a configuration of the image pickup device 20 included in the image pickup unit 105. In FIG. 2A and FIG. 2B, a Z direction perpendicular to the drawing is defined as an optical axis direction, and two directions perpendicular to each other within the drawing are defined as an X direction and a Y direction. It should be noted that the left-right direction in FIG. 2A and FIG. 2B becomes the X direction, and the up-down direction in FIG. 2A and FIG. 2B becomes the Y direction. FIG. 2A is an overall view of the image pickup device 20. FIG. 2B is an enlarged view of one pixel among a plurality of pixels included in the image pickup device 20. As shown in FIG. 2A, the image pickup device 20 includes a plurality of pixels 200, which are arranged in rows and columns in the X direction and the Y direction. It should be noted that in the first embodiment, the plurality of pixels 200 are arranged in rows and columns, but the present disclosure is not limited to this arrangement. As shown in FIG. 2B, the pixel 200 includes a microlens 201 and photoelectric conversion units 202a and 202b. A first pupil division pixel is configured by the photoelectric conversion unit 202a, and a second pupil division pixel is configured by the photoelectric conversion unit 202b. The image pickup device 20 has a range-finding function that uses an image pickup surface phase difference range-finding method. The photoelectric conversion unit 202a and the photoelectric conversion unit 202b each have a rectangular shape with the Y direction as the longitudinal direction, and are formed to have the same size. In addition, the photoelectric conversion unit 202a and the photoelectric conversion unit 202b are arranged symmetrically with respect to a perpendicular bisector of the microlens 201 along the Y direction as the axis of symmetry. It should be noted that in the first embodiment, the shape of the image pickup surface in the pupil division pixel is circular, but the present disclosure is not limited to this, and the shape of the image pickup surface in the pupil division pixel may be any shape. In addition, the arrangement direction of the pupil division pixels is the X direction in the first embodiment, but the present disclosure is not limited to this, and the arrangement direction of the pupil division pixels may be, for example, the Y direction. In addition, the number of the pupil division pixels arranged is two in the first embodiment, but the present disclosure is not limited to this, and the number of the pupil division pixels arranged may be, for example, three or more.

The image pickup unit 105 is capable of obtaining an image A that is based on image signals output from the first pupil division pixels of the respective pixels 200, and an image B that is based on image signals output from the second pupil division pixels of the respective pixels 200. The image A and the image B are in a relationship having a parallax in accordance with the distance from an in-focus position, that is, the image A and the image B are viewpoint images from different viewpoints. The photoelectric conversion unit 202a and the photoelectric conversion unit 202b in each of the pixels 200 perform photoelectric conversion in accordance with the amount of light received, with respect to different light beams incident via the microlens 201, respectively. In other words, in each of the pixels 200, the photoelectric conversion is performed with respect to optical images corresponding to light beams, which have passed through different regions of the exit pupil of the optical system 104, respectively. The image A and the image B are generated based on the light beams that have passed through the different regions of the exit pupil (the light beams that have passed through pupil division regions). Therefore, the subject is captured (photographed) at a photographing position that is shifted by a difference in centroid positions of the pupil division regions, resulting in the parallax. In this way, the image A and the image B correspond to a group of images (an image group) obtained by capturing an image of the subject (by photographing the subject) from different viewpoints. In the first embodiment, the image A and the image B that have been obtained by the image pickup device 20 (the image pickup unit 105) are used to derive a distance distribution of the subject within an image pickup range (an image capturing range). It should be noted that as the method for obtaining the image A and the image B, for example, a method of obtaining the image A and the image B from a group of images that have been captured by a plurality of image pickup apparatuses that have been installed at an interval equal to a distance of the base-line length may be adopted. In addition, as another method for obtaining the image A and the image B, for example, a method of obtaining the image A and the image B from a group of images that have been captured by one image pickup apparatus that includes a plurality of optical systems and a plurality of image pickup units (such as a two-lens camera or a multi-lens camera) may be adopted.

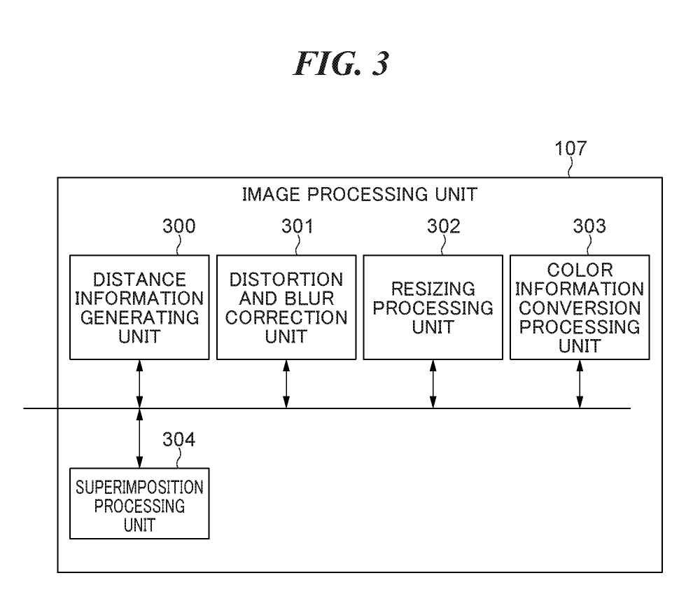

FIG. 3 is a block diagram that illustrates an example of a software configuration (functions) of the image processing unit 107. As shown in FIG. 3, the image processing unit 107 (a generating unit serving as a generating means) includes a distance information generating unit 300, a distortion and blur correction unit 301, a resizing processing unit 302, a color information conversion processing unit 303, and a superimposition processing unit 304. The distance information generating unit 300 obtains defocus amounts in a photographed image (a captured image) and generates a defocus map image that indicates a distribution state of the defocus amounts in the photographed image (the captured image) (a generating step). Specifically, the distance information generating unit 300 analyzes image signals that have been obtained by the image pickup unit 105 to generate a defocus map image as data of an additional information distribution corresponding to an image that is based on the image signals. It should be noted that the processing of calculating the defocus amounts is a publicly known technique (see, for example, Japanese Laid-Open Patent Publication (kokai) No. 2022-181027), and therefore a description thereof will be omitted.

The distortion and blur correction unit 301 corrects image distortion caused by the characteristics of the optical system 104 and image blur caused by camera shake or the like, in an image to be displayed on the display unit 109 (an image for display). The resizing processing unit 302 performs a resizing processing with respect to the defocus map image so that the defocus map image is capable of being adapted to the resolution of the image for display. The color information conversion processing unit 303 performs a processing that converts the values of the defocus map image into color information. The superimposition processing unit 304 performs a processing that superimposes the color information, which has been obtained by the color information conversion processing unit 303, onto the image for display (the captured image), thereby generating a map superimposed image.

In the first embodiment, the camera 100 uses depth information, distance information, and the like of the subject in the captured image. The depth information is information corresponding to the distance distribution in a depth direction (a direction of the depth) of the subject in the image pickup range. The distance information is two-dimensional information that indicates a distribution of the defocus amounts or the like of the image at the respective pixels of the captured image. As an example, the defocus amount is a value normalized by a depth of focus (for example, the depth of focus is 1Fδ, where F is an aperture value and δ is the diameter of the permissible circle of confusion). It should be noted that regarding the aperture value F, a fixed value across the entire surface, with the aperture value near the center of the image height as the representative value may be used, or an aperture value taking into account that the aperture value at the peripheral image height becomes dark due to vignetting of the optical system 104 may be used. In addition, the distance information may be any information that corresponds to the distance distribution in the depth direction of the subject in the image pickup range. The distance information may be, for example, distribution information of the defocus amounts before normalization by the depth of focus, a depth map indicating subject distances corresponding to the respective pixels 200, or two-dimensional information indicating the phase difference used to derive the defocus amount. The phase difference in the two-dimensional information corresponds to a relative image shift amount between different viewpoints. Alternatively, a distance map converted into actual distance information on the subject side via the position of the focusing lens of the optical system 104 is capable of being used as the distance information. In this way, any information is capable of being used as the distance information as long as it is information indicating a change in accordance with the distance distribution in the depth direction. The user who uses the camera 100 performs photographing in a state where the depth adjustment has been performed while visually recognizing the map superimposed image that has been displayed on the display unit 109.

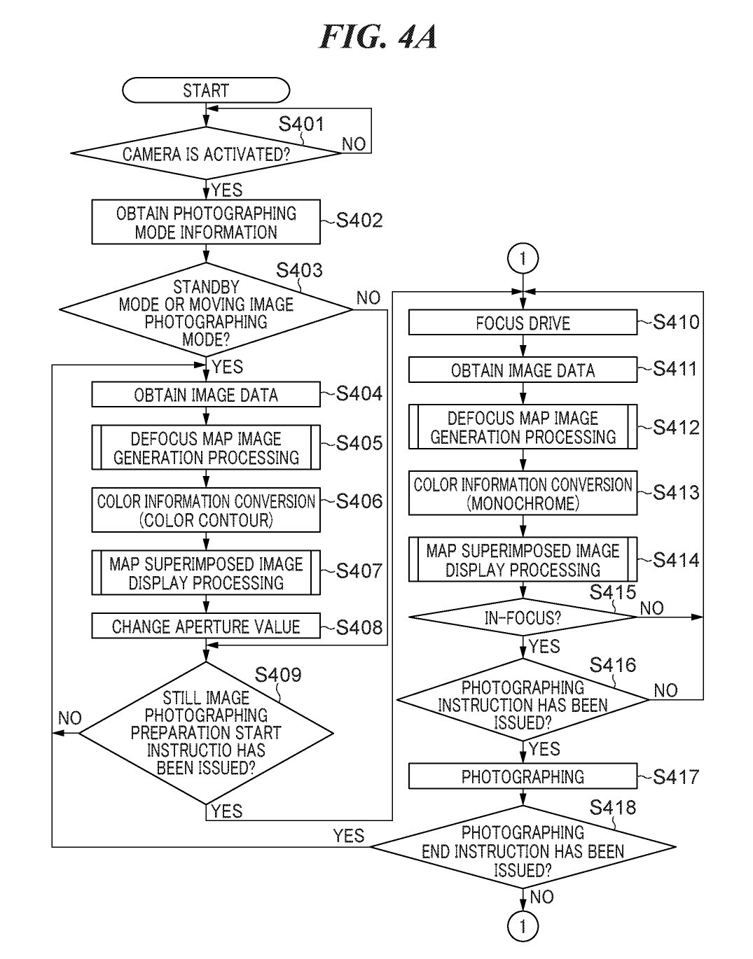

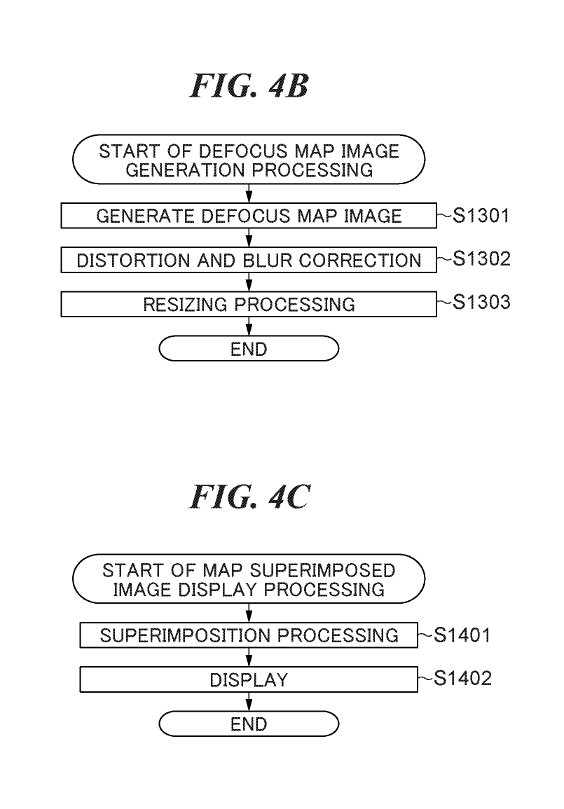

FIG. 4A, FIG. 4B, and FIG. 4C are flowcharts that show processing executed by the camera. FIG. 4A is a flowchart that shows the overall processing executed by the camera. FIG. 4B is a flowchart that shows a processing executed in a step S405, which is a subroutine of the flowchart shown in FIG. 4A. FIG. 4C is a flowchart that shows a processing executed in a step S407, which is a subroutine of the flowchart shown in FIG. 4A. A program that is based on the flowchart shown in FIG. 4A is stored in the ROM 102. The system control unit 101 reads out this program from the ROM 102 and loads it into the RAM 103, thereby starting execution of the program. As shown in FIG. 4A, in a step S401, when a power switch (not shown) of the operation input unit 110 is operated or a button operation of the operation input unit 110 is performed, the system control unit 101 puts the camera 100 into an operable state, that is, the camera 100 is started up (is activated).

In a step S402, the system control unit 101 obtains photographing mode information about the photographing mode, which has been stored in the RAM 103.

In a step S403, the system control unit 101 determines whether the photographing mode currently selected in the camera 100 is the standby mode or the moving image photographing mode, or the photographing mode currently selected in the camera 100 is not the standby mode or the moving image photographing mode, based on the photographing mode information that has been obtained in the step S402. As a result of the determination in the step S403, in the case of being determined that the photographing mode currently selected in the camera 100 is the standby mode or the moving image photographing mode (YES in the step S403), the processing proceeds to a step S404. On the other hand, as the result of the determination in the step S403, in the case of being determined that the photographing mode currently selected in the camera 100 is not the standby mode or the moving image photographing mode (NO in the step S403), the processing proceeds to a step S409.

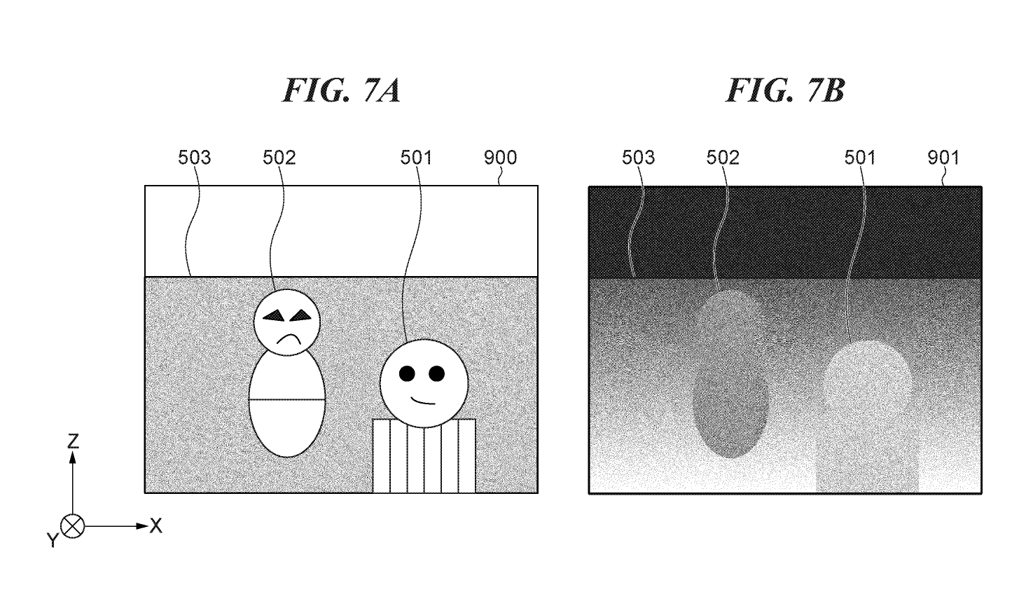

In the step S404, the system control unit 101 obtains image data. At this time, in order to display the state of the image pickup range on the display unit 109, the image pickup unit 105 captures (photographs) a captured image under the control of the system control unit 101. Then, this captured image is obtained as the image data. In addition, the image data includes data of the image A that is based on the first pupil division pixels, data of the image B that is based on the second pupil division pixels, and data of an added image of the image A and the image B (the image A + the image B). The added image of the image A and the image B is an image corresponding to a state in which the pupil division has not been performed, and is used as the image for display. This will be described below with reference to FIG. 7A and FIG. 7B.

In the step S405, the system control unit 101 controls the image processing unit 107 to perform a processing that generates a defocus map image ( a defocus map image generation processing). The defocus map image generation processing will be described with reference to FIG. 4B.

As shown in FIG. 4B, in a step S1301, the distance information generating unit 300 of the image processing unit 107 generates a defocus map image corresponding to the image for display, based on the image A and the image B that have been obtained in the step S404.

In a step S1302, the distortion and blur correction unit 301 of the image processing unit 107 performs distortion aberration correction and electronic image blur correction with respect to the image for display (the captured image) that has been obtained in the step S404 and the defocus map image that has been generated in the step S1301. It should be noted that the distortion aberration correction and the electronic image blur correction are publicly known techniques, and therefore descriptions thereof will be omitted.

In a step S1303, the resizing processing unit 302 of the image processing unit 107 performs the resizing processing so that the resolution of the defocus map image that has been corrected in the step S1302 becomes the same as the resolution of the image for display. After the step S1302 is executed, the processing proceeds to a step S406.

As shown in FIG. 4A, in the step S406, the system control unit 101 controls the color information conversion processing unit 303 of the image processing unit 107 to perform a processing for conversion into color information. Specifically, the color information conversion processing unit 303 converts the defocus amounts that are the basis of the defocus map image, which has been subjected to the resizing processing in the step S1303, into color information about colors that are easily visually-recognized by the user. It should be noted that the step S406 is a process that is performed after it is determined in the step S403 that the photographing mode currently selected in the camera 100 is the standby mode or the moving image photographing mode. For this reason, in the step S406, a processing of converting the defocus map image into a color contour that makes it easier to visually recognize the overall depth, is performed. This color contour will be described below.

In the step S407, the system control unit 101 performs a processing that displays a map superimposed image (a map superimposed image display processing). The map superimposed image display processing will be described with reference to FIG. 4C.

As shown in FIG. 4C, in a step S1401, the system control unit 101 controls the superimposition processing unit 304 of the image processing unit 107 to generate a map superimposed image. Specifically, the superimposition processing unit 304 transparently superimposes the color information converted from the defocus amounts in the step S406 (the defocus map image) onto the image for display, which has been corrected in the step S1302. As a result, a map superimposed image is generated.

In a step S1402, the system control unit 101 performs a control that displays, on the display unit 109, the map superimposed image that has been generated in the step S1401. After the step S1402 is executed, the processing proceeds to a step S408.

As shown in FIG. 4A, in the step S408, the system control unit 101 performs a change processing that changes the aperture value of the optical system 104. For example, suppose that the user visually recognizes an image that has been displayed on the display unit 109 and notices that a person, who is a subject in the image, is not within the depth. In this case, the user performs an operation, which changes the aperture value of the optical system 104 to a smaller aperture value (the small aperture value side), via the operation input unit 110. The system control unit 101 receives a signal generated by the operation that changes the aperture value of the optical system 104 to the small aperture value side, and performs a control that drives the diaphragm of the optical system 104. As a result, it is possible to perform the change processing that changes the aperture value of the optical system 104.

In the step S409, the system control unit 101 determines, based on an operation on the operation input unit 110, whether or not a still image photographing preparation start instruction (a still image photographing preparation instruction) has been issued. This determination is made, for example, in the middle of an operation of a shutter button (not shown) provided on the operation input unit 110, that is, in response to half-pressing of the shutter button (a photographing preparation start instruction), or in response to an operation of another button that has been assigned to autofocus. Then, as a result of the determination in the step S409, in the case of being determined that a still image photographing preparation start instruction has been issued (YES in the step S409), the processing proceeds to a step S410. On the other hand, as the result of the determination in the step S409, in the case of being determined that a still image photographing preparation start instruction has not been issued (NO in the step S409), the processing returns to the step S404, and the subsequent steps are executed in order.

In the step S410, the system control unit 101 causes to drive the focusing lens of the optical system 104, based on the defocus amount. It should be noted that in the step S410, the system control unit 101 is also capable of setting an AF frame in a partial region of the image data that has been obtained in the step S404 and calculating focus information based only on the subject within the AF frame. After the step S410 is executed, the processing proceeds to steps S411 to S414 in this order.

In the step S411, the same process as in the step S404 is performed.

In the step S412, the same process as in the step S405 is performed.

In the step S413, the system control unit 101 controls the color information conversion processing unit 303 of the image processing unit 107 to perform a processing for conversion into color information. As this processing for conversion into color information, since the photographing mode during this processing for conversion into color information is in preparation for still image photographing (is the still image photographing mode), a conversion processing is performed so as to become one color that makes it easy to confirm (check) the focus around a main subject. In particular, the main subject portion is converted so as not to have color so that the user is able to easily perform confirmation (checking).

In the step S414, the same process as in the step S407 is performed.

In a step S415, the system control unit 101 determines whether or not an in-focus state has been achieved as a result of the focus driving that has been continuously performed since the step S410. As a result of the determination in the step S415, in the case of being determined that an in-focus state has been achieved (YES in the step S415), the processing proceeds to a step S416. In this case, the system control unit 101 stops the focus driving. On the other hand, as the result of the determination in the step S415, in the case of being determined that an in-focus state has not been achieved (NO in the step S415), the processing returns to the step S410, and the subsequent steps are executed in order.

In the step S416, the system control unit 101 determines, based on an operation on the operation input unit 110, whether or not the operation of the shutter button has been completed, that is, whether or not a photographing instruction has been issued (full-pressing of the shutter button has been performed). As a result of the determination in the step S416 , in the case of being determined that a photographing instruction has been issued (YES in the step S416), the processing proceeds to a step S417. On the other hand, as the result of the determination in the step S416, in the case of being determined that a photographing instruction has not been issued (NO in the step S416), the processing returns to the step S410, and the subsequent steps are executed in order.

In the step S417, the system control unit 101 performs the control of a photographing operation.

In a step S418, the system control unit 101 determines, based on an operation on the operation input unit 110, whether or not the shutter button has been released, that is, whether or not a photographing end instruction has been issued. As a result of the determination in the step S418, in the case of being determined that a photographing end instruction has been issued (YES in the step S418), the processing returns to the step S404, and the subsequent steps are executed in order. On the other hand, as the result of the determination in the step S418, in the case of being determined that a photographing end instruction has not been issued (NO in the step S418), the processing returns to the step S410, and the subsequent steps are executed in order.

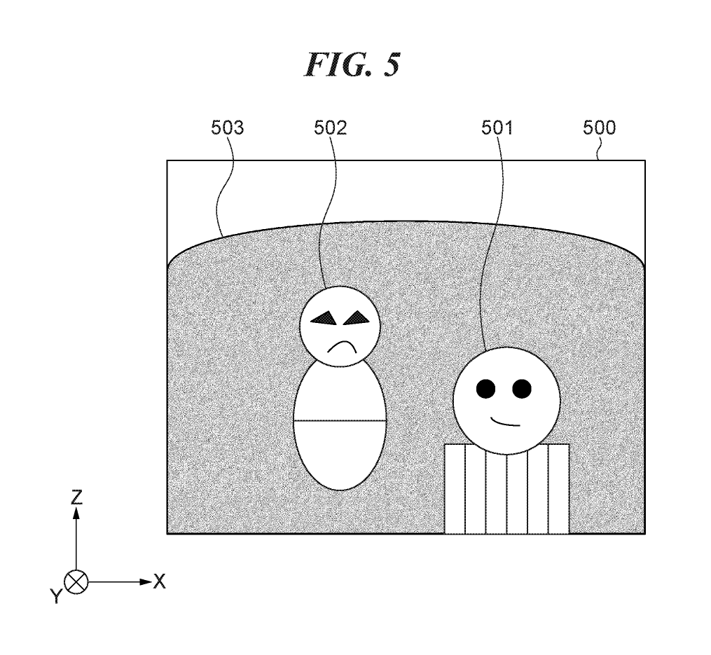

The images processed in the flowcharts shown in FIG. 4A, FIG. 4B, and FIG. 4C will now be described with reference to FIGS. 5 to 9. FIG. 5 is a diagram that illustrates an example of the captured image. A captured image (an image for display) 500 shown in FIG. 5 includes a person subject 501, a person subject 502, and a horizon 503. Of the person subject 501 and the person subject 502, the person subject 502 stands at a position farther away from the camera 100 than the person subject 501. The horizon 503 is deformed (distorted) due to the influence of distortion aberration caused by the optical system 104, and this deformation (distortion) is expressed in an exaggerated manner. Therefore, the horizon 503 with its exaggerated deformation looks unnatural in FIG. 5 because it is different from the actual scene. In addition, it is assumed that the person subject 501 is within the depth and is in focus. On the other hand, it is assumed that the person subject 502 is slightly out of the depth and is out of focus. In the first embodiment, it is assumed that the depth range is adjusted by changing the aperture value in the step S408 so that the person subject 502 also becomes within the depth, and then photographing is performed. In addition, it is assumed that the size of the captured image 500 is 6000 pixels in the horizontal direction and 4000 pixels in the vertical direction.

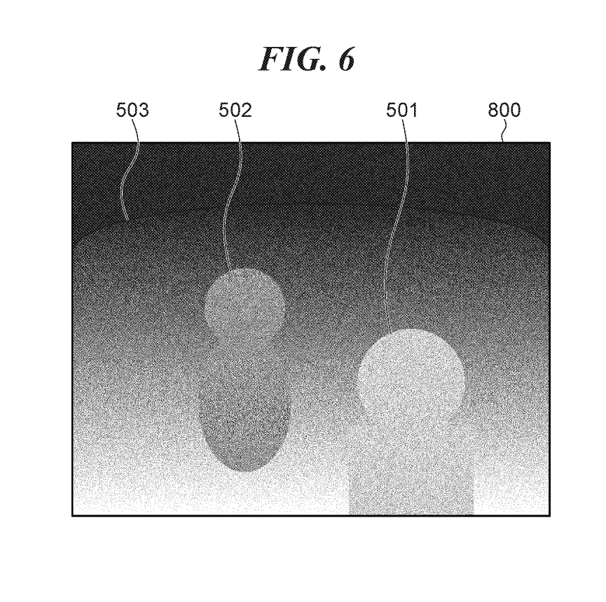

FIG. 6 is a diagram that illustrates an example of a defocus map image to be superimposed on the captured image shown in FIG. 5. A defocus map image 800 shown in FIG. 6 is generated by the distance information generating unit 300 of the image processing unit 107 in the step S1301. In the defocus map image 800, the defocus amount normalized by the depth of focus is converted into a grayscale value and visualized. In this case, in the defocus map image 800, the smaller the subject distance (the distance from the camera 100 to the subject) of the pixel, the closer the pixel value is to white (the higher the pixel value), and the larger the subject distance of the pixel, the closer the pixel value is to black (the lower the pixel value). In addition, an in-focus region (a focused region) is expressed in a continuous grayscale, such as by a gray display of “15%”. For example, the person subject 501, which is the in-focus region, is expressed by a gray display of “15%”. In addition, the person subject 502, which is in a back-focus state, is expressed by a gray display of “35%”. Furthermore, in the defocus map image 800, similar to the captured image 500, the horizon 503 is deformed (distorted) due to the influence of distortion aberration caused by the optical system 104, and this deformation (distortion) is expressed in an exaggerated manner. It should be noted that it is assumed that the size of a minute block when calculating the defocus amount is 10 pixels in the horizontal direction and 10 pixels in the vertical direction. In addition, it is assumed that the size of the defocus map image 800 is 600 pixels in the horizontal direction and 400 pixels in the vertical direction.

As described above, in the step S1302, the distortion and blur correction unit 301 of the image processing unit 107 performs the distortion aberration correction and the electronic image blur correction (hereinafter, the electronic image blur correction is simply referred to as “image blur correction”) with respect to the captured image and the defocus map image. FIG. 7A and FIG. 7B are diagrams that illustrate an example of a captured image after distortion and blur correction and an example of a defocus map image after the distortion and blur correction. FIG. 7A shows a corrected captured image 900. FIG. 7B shows a corrected defocus map image 901. In both the corrected captured image 900 and the corrected defocus map image 901, the deformation due to the distortion aberration has been corrected. In addition, in the step S1303, the resizing processing unit 302 of the image processing unit 107 performs the resizing processing so that the resolution of the corrected defocus map image 901 becomes the same as the resolution of the corrected captured image 900. In the first embodiment, the size of the corrected defocus map image 901 is 600 pixels in the horizontal direction and 400 pixels in the vertical direction. The size of the corrected captured image 900 is 6000 pixels in the horizontal direction and 4000 pixels in the vertical direction. In this case, an enlargement processing is performed with respect to the corrected defocus map image 901, resulting in that the corrected defocus map image 901 is enlarged by ten times in both the horizontal direction and the vertical direction. It should be noted that in this enlargement processing, the nearest neighbor interpolation method is selected as the pixel interpolation calculation method. In addition, in the first embodiment, the resizing processing is performed after the distortion aberration correction and the image blur correction. Unlike a display image for viewing, it is possible to reduce the resolution of the corrected defocus map image 901 by setting of the minute block. As a result, it is possible to reduce the calculation load and the calculation scale that are required for the distortion aberration correction and the image blur correction.

As described above, in the step S406, the color information conversion processing unit 303 performs the processing that converts the defocus amount into color information. In this conversion processing, the grayscale value representing the defocus amount is converted into a color value (the color difference signal UV) by, for example, look-up table conversion or the like. The color value is not particularly limited, and for example, conversion into colors like a color contour with blue, light blue, green, yellow, and red in order of decreasing grayscale value is performed. The color scheme of the color contour is capable of being selected or set according to, for example, the user's preference or the ease of viewing the image. For example, it is also possible to select a color contour with blue, light blue, green, yellow, and red in order of increasing grayscale value. In this way, in the first embodiment, it is possible to change or adjust the type of style of the color conversion for the distance information distribution. In addition, by expressing the distance information distribution in color, even in the case where the camera 100 has a relatively small monitor, subtle differences in blur that are difficult to distinguish on the relatively small monitor can be easily visually distinguished. As a result, it is possible to improve the operability when the user performs the adjustment of the depth and the focus position.

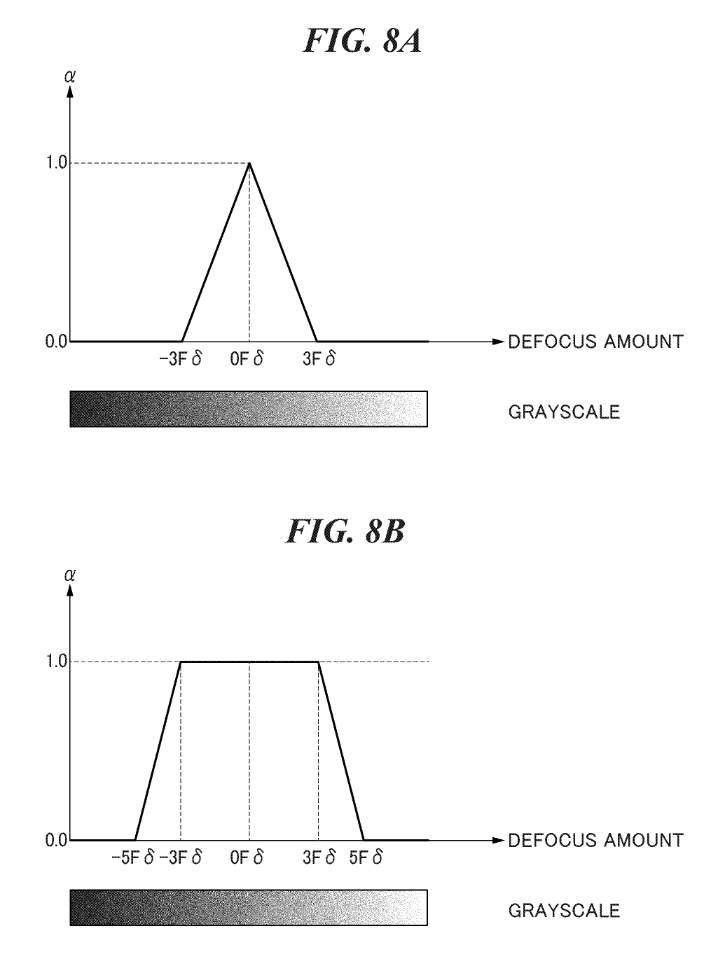

As described above, in the step S413, the color information conversion processing unit 303 performs the conversion processing from the grayscale value representing the defocus amount into color information. With this conversion processing, for example, it is possible to convert an in-focus region in the corrected defocus map image 901, which is expressed by a gray display of “15%”, into one color that is green. In a conventional peaking display, there is a high degree of dependency on the edge strength in a captured image, and even in a defocused region, there has been a possibility that the peaking display will react to strong edge portions such as building boundaries. On the other hand, in the first embodiment, by using a defocus amount that is based on the amount of parallax, it is possible to reduce the degree of dependency on the edge strength. As a result, the user is able to perform confirmation (checking) of the focus more accurately. In addition, by being able to express in-focus or out-of-focus by color, as with the color contour that has been described above, it is possible to improve the operability in terms of visibility for the user. The data conversion for making it possible to determine whether it is in focus or out of focus based on a density (a display density) of color will be described below with reference to FIG. 8A and FIG. 8B.

As described above, in the case where the photographing mode is the moving image photographing mode (or the standby mode), it is possible to generate a color image (a first map image), which uses a plurality of colors, as a defocus map image with the camera 100. In addition, in the case where the photographing mode is the still image photographing mode, it is possible to generate a monochrome image (a second map image), which uses one color, as a defocus map image with the camera 100. It should be noted that the defocus map image in the case of the still image photographing mode is not limited to a monochrome image, but may be an image in which the number of colors used is reduced compared to a color image.

FIG. 8A and FIG. 8B are diagrams for explaining conversion from a defocus amount into α information. FIG. 8A shows an example of a graph with a triangular shape, and FIG. 8B shows an example of a graph with a trapezoidal shape. In FIG. 8A and FIG. 8B, the horizontal axis represents a defocus amount, and the vertical axis represents an α value. The α information (the α value) is information that determines the density of an image. The closer the α value is to 1.0, the deeper the color of the image will be when a coloring processing is performed. In FIG. 8A, the α value is zero when the defocus amount is less than -3Fδ. In addition, when the defocus amount is greater than -3Fδ and less than 0Fδ, the α value increases linearly as the defocus amount increases. The α value corresponding to the defocus amount (0Fδ) indicated by a gray display of “15%” is 1.0. When the defocus amount is greater than 0Fδ and less than 3Fδ, the α value decreases linearly as the defocus amount increases. When the defocus amount is greater than 3Fδ, the α value is zero. In FIG. 8B, the α value is zero when the defocus amount is less than -5Fδ. In addition, when the defocus amount is greater than -5Fδ and less than -3Fδ, the α value increases linearly as the defocus amount increases. When the defocus amount is greater than -3Fδ and less than 3Fδ, the α value is 1.0. When the defocus amount is greater than 3Fδ and less than 5Fδ, the α value decreases linearly as the defocus amount increases. When the defocus amount is greater than 5Fδ, the α value is zero.

As described above, with the camera 100, it is possible to adjust the range of the defocus amounts that are colored deeply to a range desired by the user. As a result, the user is able to widen or narrow the range considered to be in focus (the width of the upper side of the trapezoid shown in FIG. 8B) depending on, for example, the purpose of using the image or the like. It should be noted that it is possible to, by a setting operation of the camera 100, designate whether the display format is a color contour or a one-color display in advance.

As described above, in the step S1401, the superimposition processing unit 304 of the image processing unit 107 transparently superimposes the color information converted from the defocus amounts (the defocus map image) onto the corrected captured image to generate a map superimposed image. For example, in the case where the display format is a color contour, a processing that replaces color difference signals UV of the captured image with color difference signals UV of the color contour is performed. In this case, it is preferable to perform conversion in advance so that the range of values of the luminance signals Y becomes smaller, so that a relatively large change in hue after superimposition is suppressed by the values of the luminance signals Y in the captured image. Specifically, in the case where the original range of values of the luminance signals Y is a value range of 8 bits from 0 to 255, the conversion is performed so as to become, for example, a value range of 20 to 235.

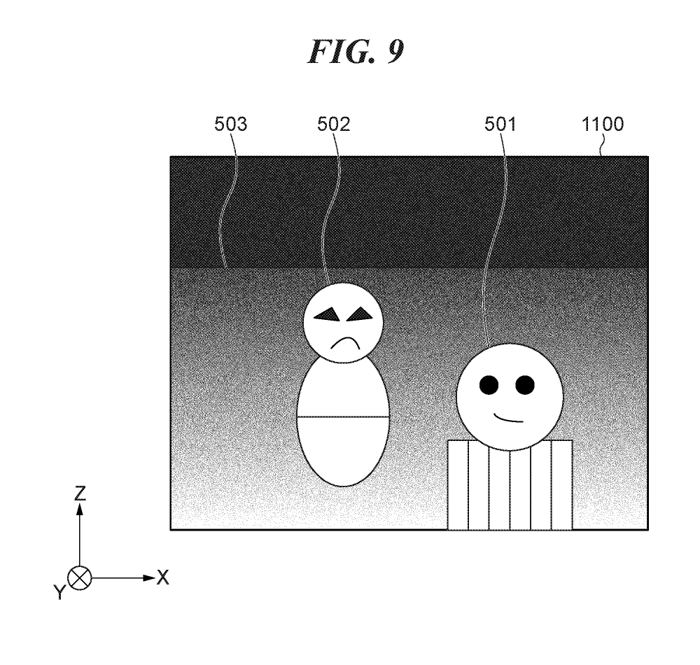

FIG. 9 is a diagram that illustrates an example of the map superimposed image. A map superimposed image 1100 shown in FIG. 9 is an image in which the corrected defocus map image 901 shown in FIG. 7B is superimposed onto the corrected captured image 900 shown in FIG. 7A. The map superimposed image 1100 is an image displayed in gray (an image expressed by a gray display) for the convenience of filing the application of the present disclosure, but in reality the map superimposed image 1100 is an image displayed in color (an image expressed by a color display) (an image displayed in color contour (an image expressed by a color contour display)).

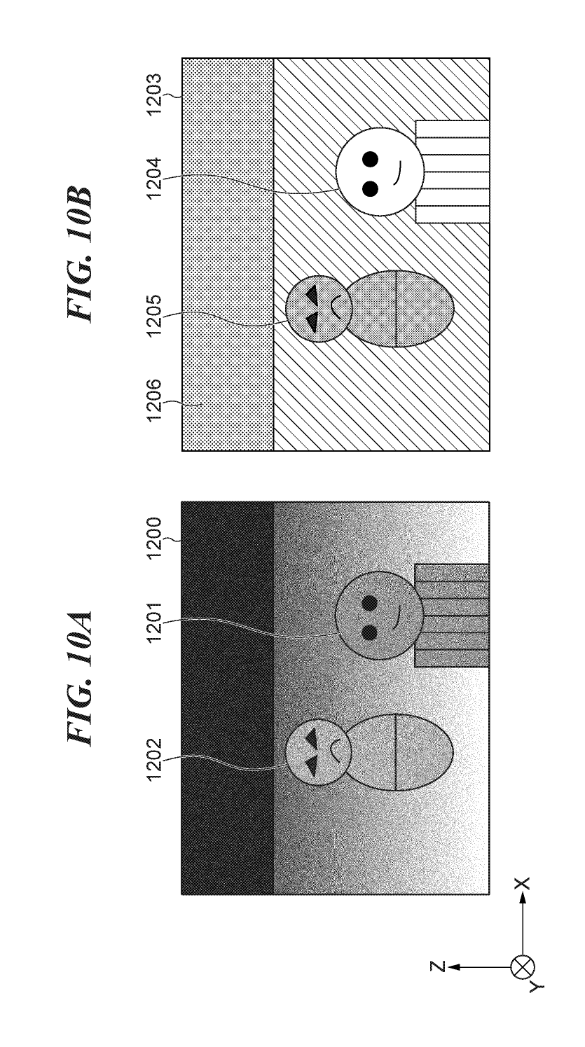

FIG. 10A and FIG. 10B are diagrams that illustrate examples of a visual recognition state of the map superimposed image. FIG. 10A is a diagram that shows a map superimposed image in which a color defocus map image is superimposed. FIG. 10B is a diagram that shows a map superimposed image in which a monochrome defocus map image is superimposed. In a map superimposed image 1200 shown in FIG. 10A, a person subject 1201 is within the depth and is in focus. On the other hand, in the map superimposed image 1200, a person subject 1202 is slightly out of the depth and is out of focus. It should be noted that in the step S413, in the case where the display format is a one-color display, a weighted addition of the captured image and one-color YUV signal values is performed based on the α value. The user is able to visually recognize a captured image on which a defocus map image has been superimposition-processed transparently. In this case, the user is able to easily understand (grasp) the correspondence relationship with information about the depth and the focus, and therefore, is able to perform the adjustment of the depth and the focus while confirming (checking) the state of the depth and the focus in the photographing scene. In a map superimposed image 1203 shown in FIG. 10B, unlike a color contour display, the depth is represented by the density of one color. A person subject 1204 within the map superimposed image 1203 is within the depth and is in focus, and the defocus map image is transparent to the entire person subject 1204. In addition, in the map superimposed image 1203, a person subject 1205 is slightly out of the depth and is out of focus, and the depth of the person subject 1205 is indicated by a medium density of the defocus map image. Similarly, the depth of a subject 1206 other than the person subject 1204 and the person subject 1205 is indicated by the density of color. The subject 1206 is displayed in a deeper color because the subject 1206 is located further deeper than the person subject 1205. It should be noted that the camera 100 may extract edges from the captured image and composite the extracted edges with the color conversion information. In this case, since the edges, from which colors of the captured image have been removed, are used, color mixing between the color information converted from the defocus amounts and the colors of the captured image is suppressed. As a result, the visibility of the defocus map image is improved.

As described above, in the case where the photographing mode of the camera 100 is the moving image photographing mode or the standby mode, a defocus map image in color contour format (the first map image) is superimpos ed and displayed. On the other hand, in the case where the photographing mode of the camera 100 is the still image photographing mode, a defocus map image in one color format (the second map image) is superimposed and displayed. In this way, the camera 100 becomes able to perform display regarding the defocus amounts suitable for a plurality of photographing modes (photographing states), that is, perform the display of the defocus map image. For example, if a defocus map image in color contour format is superimposed on a captured image obtained in the still image photographing mode and is displayed, the user may be distracted by the flickering of colors around the main subject, which may make it difficult to confirm (check) whether or not the main subject is in focus. However, with the camera 100, a defocus map image in one color format is superimposed on a captured image obtained in the still image photographing mode and is displayed. As a result, the flickering of colors around the main subject is suppressed, making it possible to confirm (check) whether or not the main subject is in focus. It should be noted that as for the timing of displaying the map superimposed image, it is preferable that the map superimposed image, in which the captured image and the defocus map image in one color format are superimposed, is displayed, for example, at a timing when the start of photographing in the still image photographing mode has been instructed. Alternatively, it is preferable that the map superimposed image, in which the captured image and the defocus map image in color contour format are superimposed, is displayed, for example, at a timing when the end of photographing in the still image photographing mode has been instructed and the photographing mode has been switched to the standby mode.

In addition, as described above, in the step S1402, the system control unit 101 performs the control that displays the map superimposed image on the display unit 109. As a result, the user is able to confirm (check) the map superimposed image. In this map superimposed image, the distortion aberration and the like have been corrected. As a result, the unnatural appearances of the subject and the like within the map superimposed image are eliminated and the subject and the like within the map superimposed image are displayed in a natural state. In addition, the defocus map image included in the map superimposed image allows the state of the depth and the focus of the subject and the like that are within the map superimposed image to be understood (grasped). As a result, it is possible to perform the operation that changes the aperture value of the optical system 104 to a smaller aperture value (the small aperture value side) so that, for example, the person subject 502 within the map superimposed image 1100 becomes within the depth.

As described above, in the step S416, the system control unit 101 determines whether or not a photographing instruction has been issued (full-pressing of the shutter button has been performed). Then, as the result of the determination in the step S416, in the case of being determined that a photographing instruction has been issued, the processing proceeds to the step S417 and the step S418 in this order. In the step S408, the aperture value of the optical system 104 is changed to a smaller aperture value (the small aperture value side). As a result, the depth becomes deeper, and the person subject 502 that has been in the back-focus state also becomes in a state of being within the depth. In addition, this state is displayed as an image in which the display of the color indicating the in-focus region (the focused region) has changed. In this way, the user is able to adjust the aperture value while visually recognizing the map superimposed image. In addition, the user is able to confirm (check) that a desired color is superimposed on the person subject 502, that is, that the person subject 502 has been within the depth, and then instruct the camera 100 to perform photographing. As described above, the user is able to optimally determine setting conditions for photographing while confirming (checking) the depth. In addition, it is possible to suppress the occurrence of noise degradation due to an increase in ISO sensitivity caused by excessively being set to a smaller aperture value (the small aperture value side) and the occurrence of subject blur due to an increase in exposure time.

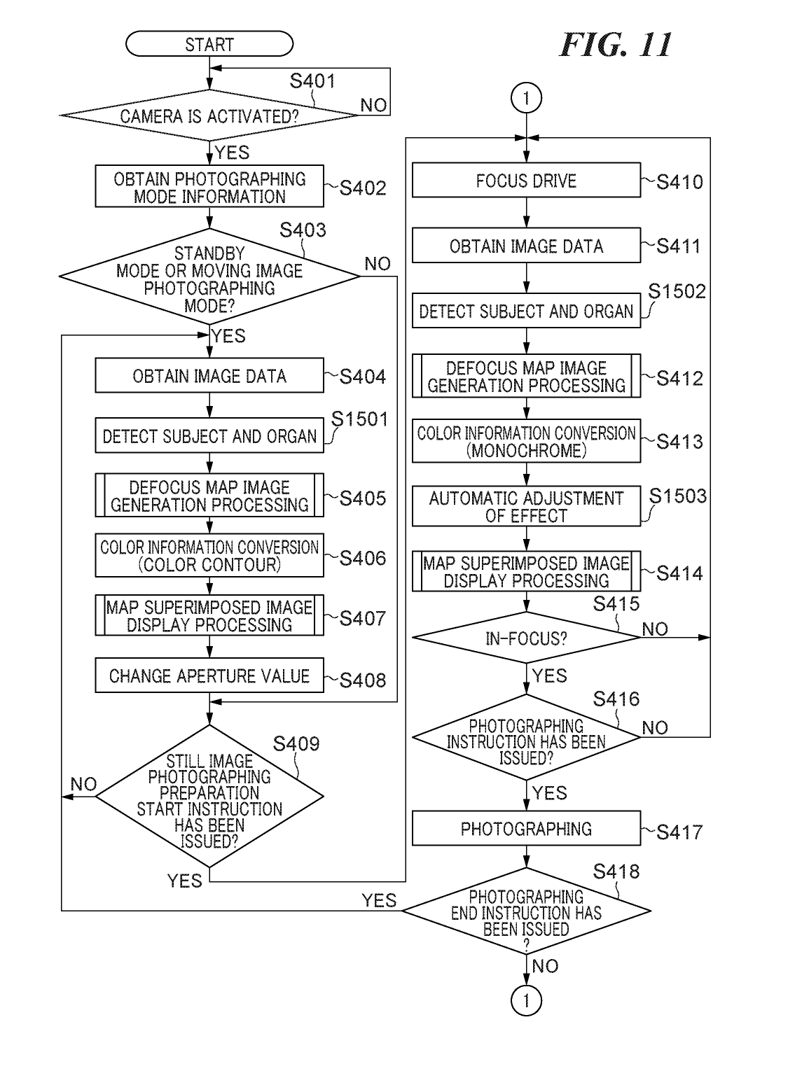

A second embodiment of the present disclosure will be described below with reference to FIG. 11. The following description will focus on the differences from the above-described first embodiment, and descriptions of the similar matters will be omitted. FIG. 11 is a flowchart that shows processing executed by a camera according to the second embodiment. The flowchart shown in FIG. 11 is a flowchart in which steps S1501, S1502, and S1503 are added to the flowchart shown in FIG. 4A. The step S1501 is executed between the step S404 and the step S405. The step S1502 is executed between the step S411 and the step S412. The step S1503 is executed between the step S413 and the step S414. As shown in FIG. 11, in the step S1501, the system control unit 101 detects a subject in the captured image included in the image data that has been obtained in the step S404, and determines the detected subject as a main subject. In addition, in the step S1502, similar to the step S1501, the system control unit 101 detects a subject in the captured image included in the image data that has been obtained in the step S411, and determines the detected subject as a main subject. The detection of each subject is performed, for example, in the case where a subject to be a main subject has been selected by a touch operation from the captured image that has been displayed on the display unit 109. In this way, in the second embodiment, the display unit 109 also functions as a selecting means (a selecting unit) for performing an operation that selects a subject to be a main subject. In addition, the system control unit detects an organ of the main subject such as the face or eye. The detection of the organ is performed, for example, in the case where an organ (feature points) of the main subject has been selected by a touch operation from the captured image that has been displayed on the display unit 109.

In the step S1503, the system control unit 101 changes and adjusts the average density of the defocus map image (the second map image) (automatic adjustment of the effect of the defocus map image). Specifically, in the case where the main subject has been selected, the average density of a portion of the map superimposed image where the defocus map image overlaps with the main subject is reduced. Furthermore, in the case where an organ of the main subject has been selected, the average density of a portion of the map superimposed image where the defocus map image overlaps with the organ of the main subject is reduced. Alternatively, for example, a range in which the defocus map image is generated or the transparency of the defocus map image may be adjusted, or the color of the defocus map image may be changed to a color other than green, such as red or blue. In this way, in the second embodiment, the system control unit 101 also functions as a changing means (a changing unit) that changes the conditions for generating the defocus map image (the second map image). For example, as for a one-color defocus map image included in the map superimposed image 1203 shown in FIG. 10B, the density of color may be set to be lighter with respect to colored regions of the entire one-color defocus map image. In addition, the main subject may be made transparent and the density of color of the defocus map image may be set to be lighter.

In addition, the system control unit 101 may control the image processing unit 107 (a cyclic processing unit that functions as a cyclic processing means) to perform addition-averaging of the defocus amounts (hereinafter, referred to as “a cyclic processing”). For example, in the case where a moving image includes a first frame and a second frame, it is assumed that there are a first defocus map image to be superimposed on the first frame and a second defocus map image to be superimposed on the second frame. In the cyclic processing, each of defocus amounts that are the basis of the first defocus map image and each of defocus amounts that are the basis of the second defocus map image are added together and averaged, that is, the sum of the two defocus amounts is divided by two. As a result, it is possible to reduce color fluctuations (flickering) over time in the defocus map image, and it is possible to improve the operability when performing the adjustment of the depth and the focus position. In this case, in the cyclic processing, a processing that accumulates (stores) the image data in a dedicated RAM is performed, and is configured to be performed in a processing order prior to the distortion aberration correction and the image blur correction that are to be performed in the step S1302.

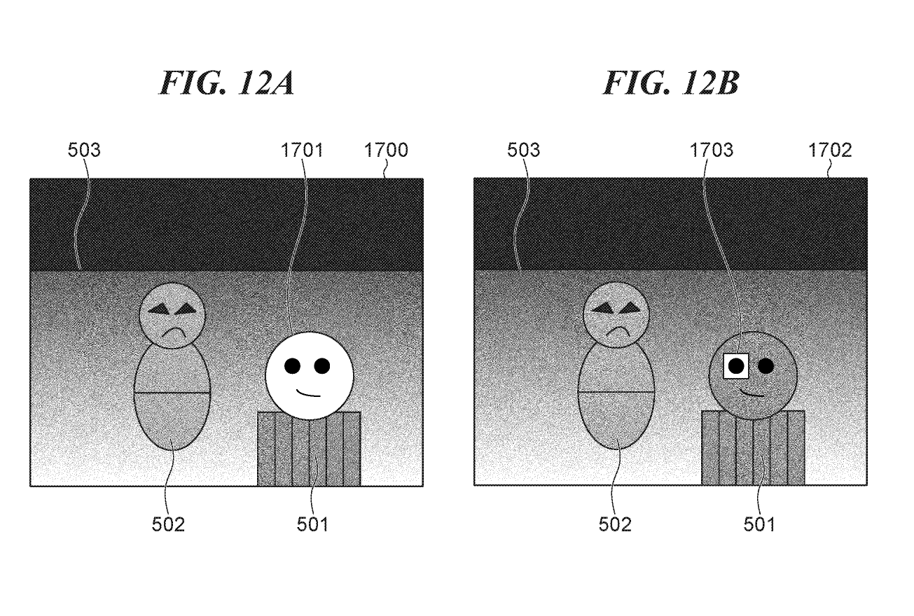

Hereinafter, modified examples of the second embodiment will be described with reference to FIG. 12A and FIG. 12B. FIG. 12A and FIG. 12B are diagrams for explaining the modified examples of the second embodiment. FIG. 12A is a diagram that shows a first modified example of the map superimposed image. FIG. 12B is a diagram that shows a second modified example of the map superimposed image. A map superimposed image 1700 shown in FIG. 12A includes a person subject 501, a person subject 502, and a horizon 503. In the map superimposed image 1700, the density of color of the color contour display of a face region1701 of the person subject 501 that is a main subject has been changed to be lighter than that of other parts of the person subject 50 other than the face region1701 (for example, the torso). Similar to the map superimposed image 1700, a map superimposed image 1702 shown in FIG. 12B includes a person subject 501, a person subject 502, and a horizon 503. In the map superimposed image 1702, the density of color of the color contour display of an eye region 1703 of the person subject 501 that is a main subject has been changed to be lighter than that of other parts of the person subject 50 other than the eye region 1703 (for example, the head and torso). In this way, with the camera 100, it is possible to perform a density change processing that changes the density of color of the color contour display so that the density of color of the color contour display of a predetermined region of one subject becomes lighter than that of other regions.

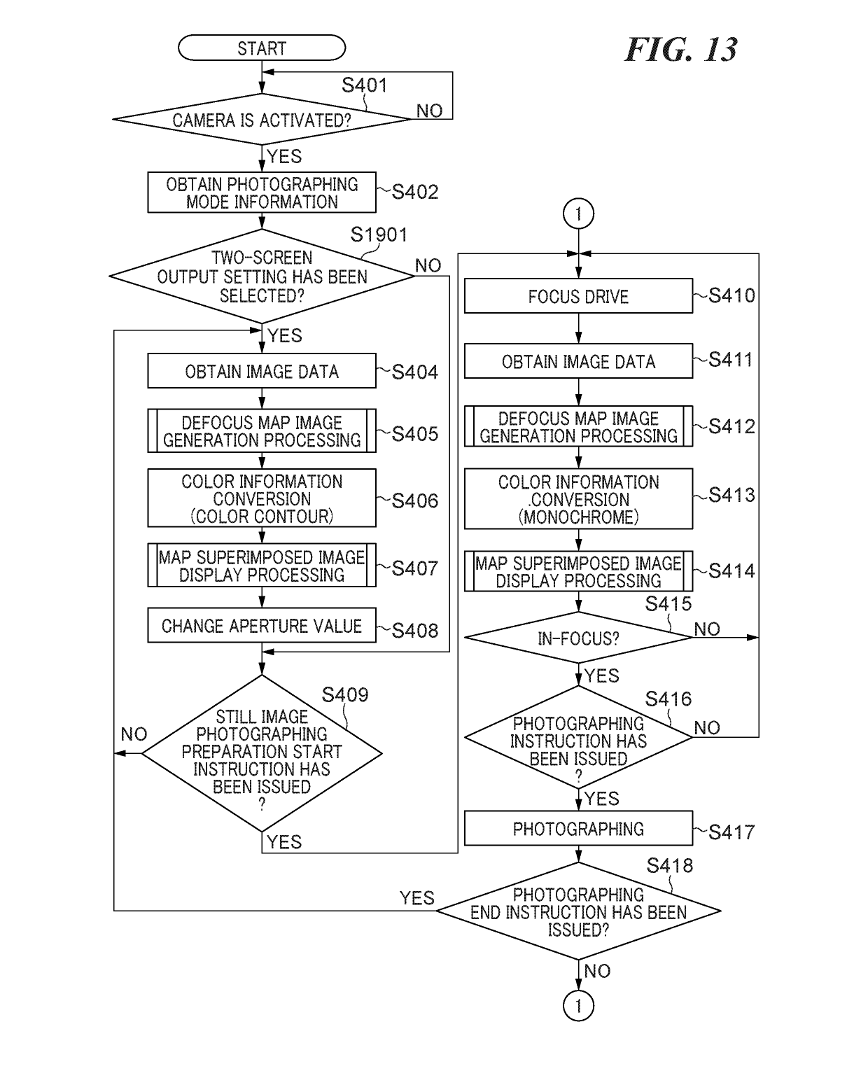

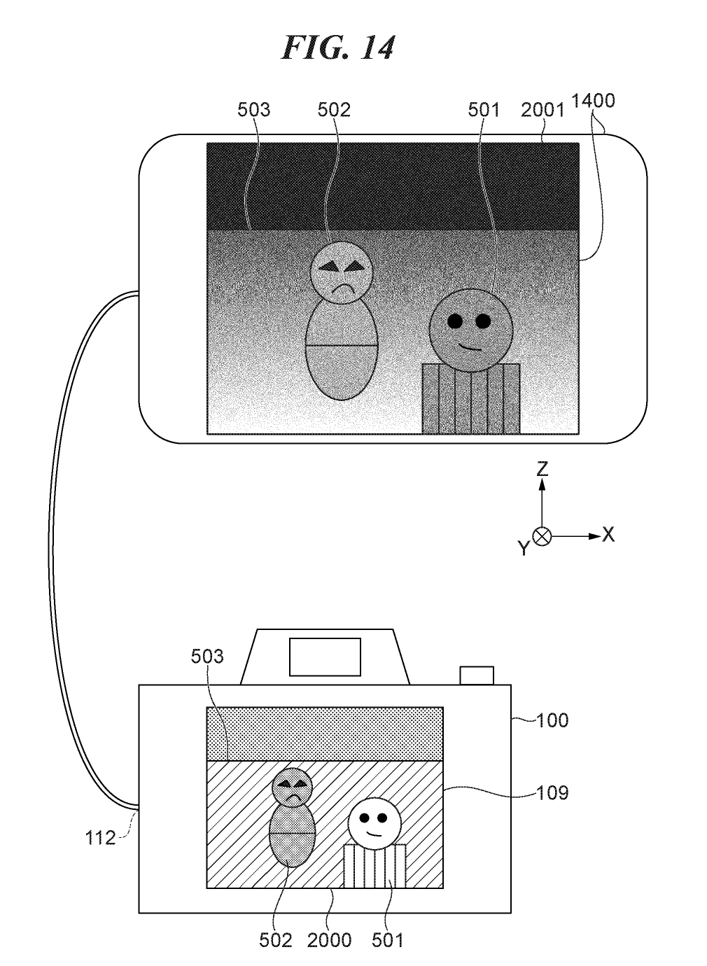

A third embodiment of the present disclosure will be described below with reference to FIG. 13 and FIG. 14. The following description will focus on the differences from the above-described first embodiment and the above-described second embodiment, and descriptions of the similar matters will be omitted. FIG. 13 is a flowchart that shows processing executed by a camera according to the third embodiment. FIG. 14 is a diagram that illustrates an example of a usage state of the camera according to the third embodiment. The flowchart shown in FIG. 13 is a flowchart in which a step S1901 is added to the flowchart shown in FIG. 4A, instead of the step S403. As shown in FIG. 14, a camera 100 is in a connected state in which a display device 1400 that is configured separately from the camera 100 is communicably connected to the camera 100 via an external output unit 112. The display device 1400 is not particularly limited as long as it includes a display unit 1401 capable of displaying a map superimposed image, and for example, a smartphone, a tablet terminal, a desktop or notebook type personal computer, or the like is capable of being used as the display device 1400.

As shown in FIG. 13, after the step S401 is executed, the step S402 is executed. In the step S402, the system control unit 101 obtains photographing mode information about the photographing mode, which has been stored in the RAM 103. This photographing mode information includes information about the photographing mode currently selected in the camera 100, as well as external output device information about the recognized external output device (in the third embodiment, the display device 1400) connected to the external output unit 112, output destination information about the output destination (the display destination) of the image, and the like. It should be noted that the output destination information may be stored in the ROM 102. In addition, for example, in the case where an HDMI terminal is connected, it is possible to set the display unit 109 of the camera 100 and the display unit 1401 of the display device 1400 as the output destination of the image (hereinafter, referred to as “a two-screen output setting”). After the step S402 is executed, the processing proceeds to the step S1901.

In the step S1901, the system control unit 101 determines whether or not the two-screen output setting has been selected as a setting for the output destination of the image. As a result of the determination in the step S1901, in the case of being determined that the two-screen output setting has been selected (YES in the step S1901), the processing proceeds to the step S404, and the subsequent steps are executed in order. On the other hand, as the result of the determination in the step S1901, in the case of being determined that the two-screen output setting has not been selected (NO in the step S1901), the processing proceeds to the step S409, and the subsequent steps are executed in order. It should be noted that in the case of the configuration shown in FIG. 14 as in the third embodiment, it is determined in the step S1901 that the two-screen output setting has been selected.

Then, the processing result obtained in the step S407, that is, a map superimposed image 2001 whose display format is a one-color display in which the photograph3ed image (the captured image) and the first map image have been superimposed, is reflected on one of the display unit 109 of the camera 100 and the display unit 1401 of the display device 1400. In addition, the processing result obtained in the step S414, that is, a map superimposed image 2000 whose display format is a color contour display in which the photographed image (the captured image) and the second map image have been superimposed, is reflected on the other of the display unit 109 of the camera 100 and the display unit 1401 of the display device 1400. In the third embodiment, as an example, as shown in FIG. 14, the map superimposed image 2001 is displayed on the display unit 1401 of the display device 1400, and the map superimposed image 2000 is displayed on the display unit 109 of the camera 100.

As described above, in the third embodiment, for example, in the case where one user performs still image photographing during performing moving image photographing, for the moving image photographing, it is possible to confirm (check) the depth of the entire screen by means of the map superimposed image 2000 whose display format is a color contour display. In addition, along with this confirmation, for the still image photographing, it is also possible to confirm (check) the focus state of the main subject by means of the map superimposed image 2001 whose display format is a one-color display.

Although the embodiments of the present disclosure have been described above, the present disclosure is not limited to the above-described embodiments, and various modifications and changes are possible within the scope of the gist of the present disclosure. The present disclosure provides a program that realizes one or more functions of each of the above-described embodiments to a system or an apparatus via a network or a storage medium. In addition, the present disclosure can also be realized by the process of one or more general-purpose processor ASICs included in a computer of the system or the apparatus reading out and executing the program. In addition, the present disclosure can also be realized by a special-purpose processor (for example, an ASIC or an FPGA) that implements one or more of the functions. Furthermore, the present disclosure can also be realized by using a combination of general-purpose and special-purpose processors. It should be noted that the term “processor” used here refers to a processor in a broad sense, and includes both a general-purpose processor and a special-purpose processor. In addition, the processing for realizing the present disclosure may be executed by only one processor, or may be executed by cooperation of a plurality of processors that are located at physically separate locations.

According to the present disclosure, it is possible to perform display regarding the defocus amounts suitable for a plurality of photographing states.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-221505, filed December 18, 2024, which is hereby incorporated by reference herein in its entirety.

What is claimed is:

1. An image pickup apparatus comprising:
an image pickup unit configured to be capable of photographing a still image and a moving image as a photographed image;
a mode switching member for switching a photographing mode among a still image photographing mode in which the still image is capable of being photographed by the image pickup unit, a moving image photographing mode in which the moving image is capable of being photographed by the image pickup unit, and a standby mode in which the image pickup apparatus is capable of standing by until switching to the still image photographing mode or the moving image photographing mode;
at least one processor; and
a memory coupled to the processor storing instructions that, when executed by the processor, cause the processor to function as:
a generating unit that obtains defocus amounts in the photographed image and generates a defocus map image that indicates a distribution state of the defocus amounts in the photographed image; and
a display control unit that performs a control that displays a superimposed image in which the photographed image and the defocus map image have been superimposed, and
wherein the generating unit, in a case where the photographing mode is the moving image photographing mode or the standby mode, as the defocus map image, generates a first map image which uses a plurality of colors, and in a case where the photographing mode is the still image photographing mode, as the defocus map image, generates a second map image in which the number of colors used is reduced compared to the first map image.

2. The image pickup apparatus according to claim 1, wherein
the generating unit converts the defocus amounts into color information about colors, and based on the color information, generates a color image as the first map image and generates a monochrome image as the second map image.

3. The image pickup apparatus according to claim 1, wherein
the generating unit, when generating the second map image, adjusts an average density of the second map image.

4. The image pickup apparatus according to claim 3, further comprising:
a selecting unit by which an operation for selecting a subject from the photographed image is performed, and
wherein the generating unit, in a case where the subject has been selected by the selecting unit, causes to reduce an average density of a portion of the superimposed image where the second map image overlaps with the subject of the photographed image.

5. The image pickup apparatus according to claim 4, wherein
the selecting unit is capable of being operated to further select feature points of the subject, and
the generating unit, in a case where the feature points have been selected by the selecting unit, causes to reduce an average density of a portion of the superimposed image where the second map image overlaps with the feature points of the photographed image.

6. The image pickup apparatus according to claim 3, wherein
the processor is caused to further function as a changing unit that changes the average density of the second map image.

7. The image pickup apparatus according to claim 6, wherein
the changing unit is capable of changing a range in which the defocus map image is generated.

8. The image pickup apparatus according to claim 1, further comprising:
an instructing member for performing operations to instruct a start and an end of photographing in the still image photographing mode and a start and an end of photographing in the moving image photographing mode, and
wherein the display control unit, at a timing when the start of photographing in the still image photographing mode has been instructed by the instructing member, as the superimposed image, performs a control that displays an image in which the photographed image and the second map image have been superimposed.

9. The image pickup apparatus according to claim 8, wherein
the display control unit, at a timing when the end of photographing in the still image photographing mode has been instructed by the instructing member and the photographing mode has been switched to the standby mode, as the superimposed image, performs a control that displays an image in which the photographed image and the first map image have been superimposed.

10. The image pickup apparatus according to claim 1, wherein
the processor is caused to further function as a cyclic processing unit that performs addition-averaging of the defocus amounts.

11. The image pickup apparatus according to claim 1, wherein
the image pickup apparatus comprises a display unit that displays the superimposed image, and is communicably connectable to a display device that is configured separately from the image pickup apparatus and displays the superimposed image, and
in a connected state in which the image pickup apparatus is communicably connected to the display device, an image, in which the photographed image and the first map image have been superimposed, is displayed as the superimposed image on one of the display unit and the display device, and an image, in which the photographed image and the second map image have been superimposed, is displayed as the superimposed image on the other of the display unit and the display device.

12. A display control apparatus comprising:
an obtaining unit configured to be capable of obtaining a still image and a moving image as a photographed image, the obtaining unit obtaining the still image in a case of a still image photographing mode and obtaining the moving image in a case of a moving image photographing mode;
at least one processor; and
a memory coupled to the processor storing instructions that, when executed by the processor, cause the processor to function as:
a generating unit that obtains defocus amounts in the photographed image and generates a defocus map image that indicates a distribution state of the defocus amounts in the photographed image; and
a display control unit that performs a control that displays a superimposed image in which the photographed image and the defocus map image have been superimposed, and
wherein the generating unit, in a case of the moving image photographing mode or a standby mode in which the image pickup apparatus is capable of standing by until switching to the still image photographing mode or the moving image photographing mode, as the defocus map image, generates a first map image which uses a plurality of colors, and in a case of the still image photographing mode, as the defocus map image, generates a second map image in which the number of colors used is reduced compared to the first map image.

13. A control method for controlling an image pickup apparatus that comprises an image pickup unit configured to be capable of photographing a still image and a moving image as a photographed image, and a mode switching member for switching a photographing mode among a still image photographing mode in which the still image is capable of being photographed by the image pickup unit, a moving image photographing mode in which the moving image is capable of being photographed by the image pickup unit, and a standby mode in which the image pickup apparatus is capable of standing by until switching to the still image photographing mode or the moving image photographing mode,
the control method comprising:
a generating step of obtaining defocus amounts in the photographed image and generating a defocus map image that indicates a distribution state of the defocus amounts in the photographed image; and
a display control step of performing a control that displays a superimposed image in which the photographed image and the defocus map image have been superimposed, and
wherein in the generating step, in a case where the photographing mode is the moving image photographing mode or the standby mode, a first map image, which uses a plurality of colors, is generated as the defocus map image, and in a case where the photographing mode is the still image photographing mode, a second map image, in which the number of colors used is reduced compared to the first map image, is generated as the defocus map image.

14. A non-transitory computer-readable storage medium storing a program for causing a computer to execute a control method for controlling an image pickup apparatus that comprises an image pickup unit configured to be capable of photographing a still image and a moving image as a photographed image, and a mode switching member for switching a photographing mode among a still image photographing mode in which the still image is capable of being photographed by the image pickup unit, a moving image photographing mode in which the moving image is capable of being photographed by the image pickup unit, and a standby mode in which the image pickup apparatus is capable of standing by until switching to the still image photographing mode or the moving image photographing mode,
the control method comprising:
a generating step of obtaining defocus amounts in the photographed image and generating a defocus map image that indicates a distribution state of the defocus amounts in the photographed image; and
a display control step of performing a control that displays a superimposed image in which the photographed image and the defocus map image have been superimposed, and
wherein in the generating step, in a case where the photographing mode is the moving image photographing mode or the standby mode, a first map image, which uses a plurality of colors, is generated as the defocus map image, and in a case where the photographing mode is the still image photographing mode, a second map image, in which the number of colors used is reduced compared to the first map image, is generated as the defocus map image.
